(19) United States
(12) Patent Application Publication
(10) Pub. No.: US 2014/0136826 A1
(43) Pub. Date: May 15, 2014

(54) METHOD AND APPARATUS FOR UPDATING BOOT LOADER

(71) Applicant: Electronics & Telecommunications Research Institute, Daejeon (KR)

(72) Inventor: Jang Woon PAEK, Daegu (KR)

(73) Assignee: Electronics & Telecommunications Research Institute, Daejeon (KR)

(21) Appl. No.: 14/059,016

(22) Filed: Oct. 21, 2013

(30) Foreign Application Priority Data
Nov. 13, 2012 (KR) 10-2012-0127852

(51) Int. Cl. G06F 11/14; G06F 9/445

(52) U.S. Cl. CPC G06F 11/1417; G06F 8/65
USPC 713/1

(57) ABSTRACT

Disclosed is an apparatus and method for updating a boot loader of an embedded system for a vehicle, the method including receiving and storing an update file, checking validities of a primary boot program and a secondary boot program based on update information according to the update file, and sequentially executing updates of the primary boot program and the secondary boot program. Since the secondary boot program, which is a backup boot program, maintains an executable state all the times, even if an error occurs during a boot program update, the update is executed again by use of the secondary boot program, thereby securing the safety of an embedded system for a vehicle.

### CLAIM FOR PRIORITY

This application claims priority to Korean Patent Application No. 10-2012-0127852 filed on Nov. 13, 2012 in the Korean Intellectual Property Office (KIPO), the entire contents of which are hereby incorporated by reference.

### BACKGROUND

1. Technical Field

Example embodiments of the present invention relate in general to the field of an update of a boot loader, and more specifically, to a method and apparatus for updating a boot loader that may be applied to an embedded system.

2. Related Art

An embedded system is an electronic control system in which hardware and software of a computer to perform a predetermined function are combined with each other. In general, the embedded system may come with a built-in microprocessor to perform a specified task and have a unique operating system while being provided with a program, called as a boot loader.

The embedded system accesses an external download device to download and execute an update file, thereby updating an operating system, a file system, or a boot loader.

However, during the update of the boot loader of the embedded system, if the power is shut off or an error of the update file occurs, a special hardware device is required or a complicated recovery work needs to be performed to recover the power failure or the error.

In particular, in the case in which such a problem occurs during the update of a boot loader of an embedded system for a vehicle, the vehicle needs to be dissembled, and the boot loader needs to be reinstalled by use of a hardware debugger or a ROM writer.

### SUMMARY

Accordingly, example embodiments of the present invention are provided to substantially obviate one or more problems due to limitations and disadvantages of the related art.

Example embodiments of the present invention provide a method of updating a boot loader capable of stably executing update of a boot loader of an embedded system for a vehicle.

Example embodiments of the present invention also provide an apparatus for updating a boot loader capable of stably executing update of a boot loader of an embedded system for a vehicle.

In some example embodiments, a method of updating a boot loader includes receiving and storing an update file; and checking validities of a primary boot program and a secondary boot program based on update information according to the update file, and sequentially executing updates of the primary boot program and the secondary boot program.

In the sequentially executing of the updates, after the primary boot program is updated by executing the primary boot program to load the update file, the secondary boot program may be updated.

In the sequentially executing of the updates, in a case in which the update of the primary boot program ends without being completed, the update information may be updated about the primary boot program being invalid, and after the primary boot program is updated by executing the secondary boot program to load the update file, the secondary boot program may be updated.

Here, the embedded system may be loaded in an electronic control unit for a vehicle.

In other example embodiments, an apparatus for updating a boot loader includes a memory unit, an update monitoring unit, and an update control unit. The memory unit may be configured to receive and store an update file. The update monitoring unit may be configured to check validities of a primary boot loader and a secondary boot loader based on update information according to the update file. The update control unit may be configured to sequentially execute updates of the primary boot loader and the secondary boot loader.

As is apparent from the above description, in the case in which the method and apparatus for updating a boot loader according to an example embodiment of the present invention are used, two boot programs are sequentially updated, and only when the update of a primary boot program is successfully completed, a secondary boot program may be updated.

In addition, since the secondary boot program according to an example embodiment of the present invention is a backup boot program that maintains an executable state all the times, even if an error occurs during a boot program update, the update may be executed again by use of the secondary boot program, thereby securing the safety of an embedded system for a vehicle.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram illustrating an update of an electronic control unit for a vehicle;

FIG. 2 is a flowchart illustrating a method of updating a boot loader according to an example embodiment of the present invention; and

FIG. 3 is a block diagram illustrating an apparatus for updating a boot loader according to an example embodiment of the present invention.

### DESCRIPTION OF EXAMPLE EMBODIMENTS

Example embodiments of the present invention are disclosed herein. However, specific structural and functional details disclosed herein are merely representative for purposes of describing example embodiments of the present invention; example embodiments of the present invention may be embodied in many alternate forms and should not be construed as being limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The terminology used herein is for the purpose of describing particular embodiments only and is not intended to be limiting of the invention. As used herein, the singular forms “a”, “an,” and “the” are intended to include the plural forms as well, unless the context clearly indicates otherwise. It will be further understood that the terms “comprises”, “comprising,”, “includes,” and/or “including”, when used herein, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

Hereinafter, embodiments of the present invention will be described in detail with reference to the accompanying drawings. In describing the present invention, for convenience of description the same components are denoted by the same reference numerals, and the description thereof will be omitted in order to avoid redundancy.

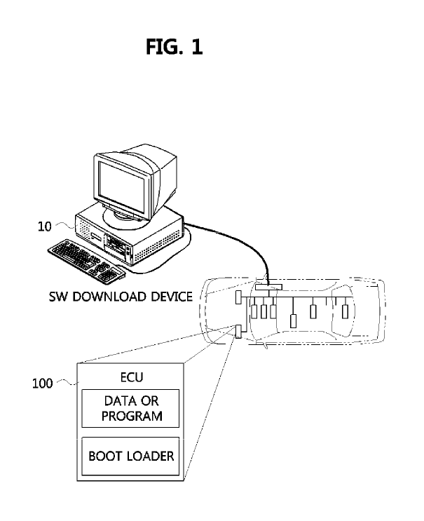

FIG. 1 is a conceptual diagram illustrating an update of an electronic control unit for a vehicle.

Referring to FIG. 1, in a case in which an update of an embedded system for a vehicle is required, the update is performed by receiving an update file from a software (SW) download device 10 of outside.

An electronic control unit (ECU) 100 is mounted on a vehicle at various parts each configured to detect and control the motion of the vehicle, and a total of about ten to hundred units of the ECU 100 is mounted on a single vehicle.

The ECU 100 serves to precisely control a core function of an engine, such as an ignition timing, a fuel injection, and an idling running. In addition, with the development of a vehicle and a computer, the ECU 100 serves to control the overall parts of a vehicle, such as a driving system and a steering system, in addition to controlling a vehicle transmission.

A vehicle network is generally divided into a multimedia network to control over multimedia devices, such as an audio system, a video system, and a navigation system, and a vehicle-purpose electronic device network to control core parts of a vehicle, such as an engine and a brake.

As a technology to communicate with the ECU 100, a controller area network (CAN), a FlexLay, and a local interconnect network (LIN) may be used. In addition, a Media Oriented Systems Transport (MOST) may be used for the multimedia network.

According to an example embodiment of the present invention, the SW download device 10 may update the ECU 100 through the CAN, FlexLay, or LIN, that is, the vehicle network enabling a communication with the ECU 100.

That is, the SW download device 10 may upload an update file to a storage medium of the ECU 100 by use of a vehicle diagnosis communication protocol on the vehicle network. The SW download device 10 may represent a computer device or a server of outside.

In addition, the update file may include information that may be able to update a boot program (a boot loader), an operating system, and various programs. Here, the boot loader may be referred to as being identical to the boot program, or may represent a module having a boot program built-in.

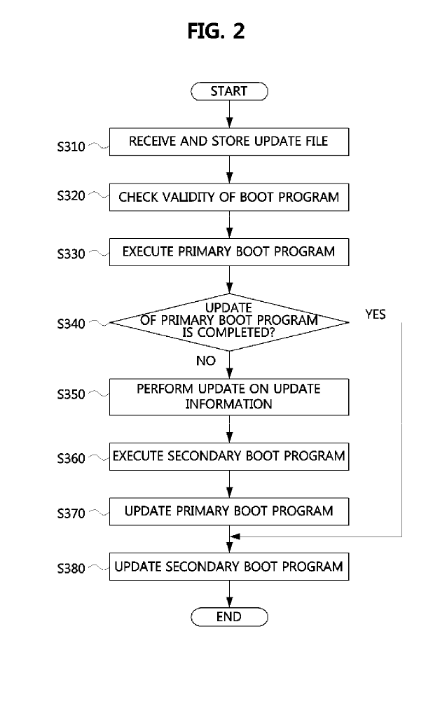

FIG. 2 is a flowchart describing a method of updating a boot loader according to an example embodiment of the present invention.

Referring to FIG. 2, a method of updating a boot loader according to an example embodiment of the present invention includes receiving and storing an update file, and sequentially executing updates of a primary boot program and a secondary boot program.

The boot program according to an example embodiment of the present invention may be mounted on an embedded system for a vehicle, such as the ECU 100. In general, a single boot program may be mounted on the ECU 100 to start the ECU 100.

However, according to an example embodiment of the present invention, two or more boot programs may be mounted on the ECU 100. For example, a primary boot program and a secondary boot program may be mounted on the ECU 100.

The method of updating the boot loader includes receiving and storing an update file, checking validities of the primary boot program and the secondary boot program based on update information according to the update file, and sequentially executing updates of the primary boot program and the secondary boot program.

In general, when updates are performed on programs built in the ECU 100, in many case, the boot program in the embedded system for a vehicle needs to be primarily updated. That is, the boot program, upon booting, executes an update file, and the update file automatically updates various programs.

An update file may be received through the SW download device 10, and the received update file may be stored (S310). The update file may be stored in a flash memory and an electrically erasable programmable read-only memory (EEPROM), and may include information that may be able to update a boot program, an operating system, and various programs.

In particular, according to an example embodiment of the present invention, the update file may include information configured to update a boot program, thereby enabling a boot program update.

A validity of the boot program is checked by use of update information according to the update file received through the SW download device 10 (S320). That is, whether a currently mounted boot program normally operates or corresponds to the newest version may be checked.

For example, validities of the primary boot program and the secondary boot program may be checked, and depending on the validities, whether to execute updates of the boot programs may be determined.

The validities of the boot programs may be checked, and then the primary boot program may be executed (S330). The executed primary boot program may load the stored update file, so that an update is executed. As for updates of the boot programs, after the update of the primary boot program is successfully completed, the second boot program may be updated.

Whether the update of the primary boot program is successfully completed may be checked (S340). If it is determined that the update of the primary boot program is successfully completed, an update of the secondary boot program is performed (S380).

The update of the primary boot program may not be successfully completed. That is, during a process of updating the primary boot program, if a power is shut off or errors occur, the update of the primary boot program may not be complete. If the update of the primary boot program ends without being completed, the primary boot program may not be executed in some cases.

For example, if a system is reset during updates of various programs due to occurrence of a problem, the update may be again executed through a boot program. However, if a problem occurs during update of the boot program, programs of the ECU 100 may not be executed any more, and thus the boot program needs to be newly installed.

Accordingly, in the case in which the update of the primary boot program is not successfully completed, the update information may be updated to include information about the primary boot program being invalid (S350)

Even if the update of the primary boot program is not successfully completed, the secondary boot program is executable.

Accordingly, by executing the secondary boot program (S360), the update file is again loaded so that the update of the primary boot program is performed (S370). In addition, whether the update of the primary boot program is successfully completed may be checked again (S340), and after the update of the primary boot program is complete, the update of the secondary boot program may be performed (S380).

Accordingly, the method of updating the boot loader according to the example embodiment of the present invention sequentially updates two or more boot programs, and only when an update of a primary boot program is successfully completed, a secondary boot program is updated.

That is, since the secondary boot program is a backup boot program, capable of maintaining an executable state all the times, even if an error occurs during update of a boot program, the update can be executed again by use of the secondary boot program. In addition, even if the update is failed, the ECU 100 may normally operate.

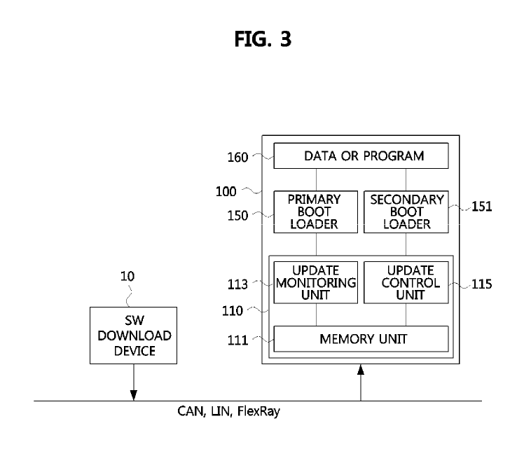

FIG. 3 is a block diagram describing an apparatus for updating a boot loader according to an example embodiment of the present invention.

Referring to FIG. 3, the ECU 100 may receive an update file through the vehicle network (the CAN, LIN, or FlexRay) from the SW download device 10.

The ECU 100 includes a boot loader update apparatus 110, a primary boot loader 150, a secondary boot loader 151, and a data or program 160. The data or program 160 may include a data or a system file that is related to an operating system.

The boot loader update apparatus 110 is an apparatus configured to perform an update of a boot loader or various programs. In particular, the ECU 100 according to an example embodiment of the present invention may include two or more boot loaders. Here, the primary boot loader 150 and the secondary boot loader 151 each may be a boot loader performing the same role.

The boot loader update apparatus 110 may be mounted inside the ECU 100, but the position thereof is not limited thereto. The boot loader update apparatus 110 includes a memory unit 111, an update monitoring unit 113 and an update control unit 115. In addition, the boot loader update apparatus 110 may be understood as a concept further including the primary boot loader 150 and the secondary boot loader 151.

The memory unit 111 may receive an update file from the SW download device 10, and store the received update file. The memory unit 111 may interoperate with the SW download device 10 through the vehicle network, such as the CAN, the FLexLay, or the LIN.

In addition, the memory unit 111 may be a flash memory and an electrically erasable programmable read-only memory (EEPROM), and may temporarily store the update file. The update file includes information that may be able to update a boot loader (a boot program), an operating system, and various programs.

The update monitoring unit 113 may check a validity of the boot program by use of update information according to the update file received from the SW download device 10 and stored.

For example, the update monitoring unit 113 may check a validity that includes information about the operation states and versions of the primary boot loader 150 and the secondary boot loader 151.

The update control unit 115 controls the updates of the boot loaders. The update control unit 115 may sequentially update the primary boot loader 150 and the secondary boot loader 151. That is, the update control unit 115, after the update of the primary boot loader 150 is successfully completed, may control the update of the secondary boot loader 151 to be executed.

In addition, the update control unit 115, in a case in which the update of the primary boot loader 150 is not successfully completed, may update the update information about the primary boot loader 150 being invalid.

For example, if a power is shut off or errors occur during a process of updating the primary boot loader, the update of the primary boot program may not be complete. If the update of the primary boot loader ends without being completed, the primary boot loader may not be executed in some cases.

Accordingly, the update control unit 115, if it is determined that the primary boot loader 150 is invalid since the update of the primary boot loader 150 is not successfully completed, executes the secondary boot loader 151 to load the update file, so that the primary boot loader 150 is updated.

In addition, the update control unit 115 may check again whether the update of the primary boot loader 150 is successfully completed. Only if it is determined from the rechecking that the update of the primary boot loader 150 is successfully completed, the update control unit 115 executes the update of the secondary boot loader 151.

That is, after the update of the primary boot loader 150 is completed, the update of the secondary boot loader 151 is executed.

The boot loader update apparatus 110 may sequentially update two or more boot loaders. Accordingly, only if the update of the primary boot loader 150 is successfully completed, the update of the secondary boot loader 151 is performed, so that the safety of the embedded system is secured.

The boot loader update apparatus according to an example embodiment of the present invention may be an apparatus configured to perform the method of updating a boot loader described as the above.

Although the memory unit 111, the update monitoring unit 113, the update control unit 115, the primary boot loader 150, and the secondary boot loader 151 according to an example embodiment of the present invention are illustrated as being independent of one another in the above description, the update monitoring unit 113, the update control unit 115, the primary boot loader 150, and the secondary boot loader 151 may be provided in a unitary form, that is, in a single physical device. In addition, each of the update monitoring unit 113, the update control unit 115, the primary boot loader 150, and the secondary boot loader 151 may be embodied as a plurality of physical devices or groups other than a single physical device or group.

The disclosure can also be embodied as computer readable programs or codes on a computer readable recording medium. The computer readable recording medium is any data storage device that can store data which can be thereafter read by a computer system. The computer readable recording medium can also be distributed in computer systems connected over a network so that the computer readable program or code is stored and executed in a distributed fashion.

While the example embodiments of the present invention and their advantages have been described in detail, it should be understood that various changes, substitutions, and alterations may be made herein without departing from the scope of the invention.

What is claimed is:

1. A method of updating a boot loader, with respect to updating an embedded system, the method comprising:
receiving and storing an update file; and
checking validities of a primary boot program and a secondary boot program based on update information according to the update file, and sequentially executing updates of the primary boot program and the secondary boot program.

2. The method of claim 1, wherein in the sequentially executing of the updates, after the primary boot program is updated by executing the primary boot program to load the update file, the secondary boot program is updated.

3. The method of claim 2, wherein in the sequentially executing of the updates,
in a case in which the update of the primary boot program ends without being completed, the update information is updated about the primary boot program being invalid; and
after the primary boot program is updated by executing the secondary boot program to load the update file, the secondary boot program is updated.

4. The method of claim 1, wherein the embedded system is loaded in an electronic control unit for a vehicle.

5. An apparatus for updating a boot loader with respect to updating an embedded system, the apparatus comprising:
a memory unit configured to receive and store an update file;
an update monitoring unit configured to check validities of a primary boot loader and a secondary boot loader based on update information according to the update file; and
an update control unit configured to sequentially execute updates of the primary boot loader and the secondary boot loader.

6. The apparatus of claim 5, wherein the update control unit, after updating the primary boot loader by executing the primary boot loader to load the update file, updates the secondary boot loader.

7. The apparatus of claim 5, wherein the update control unit, in a case in which the update of the primary boot loader ends without being completed, is configured to:
update the update information about the primary boot loader being invalid; and
after updating the primary boot loader by executing the secondary boot loader to load the update file, update the secondary boot loader.

8. The apparatus of claim 5, wherein the embedded system is loaded in an electronic control unit for a vehicle.
